(19) United States
(12) Patent Application Publication
(10) Pub. No.: US 2020/0012271 A1
(43) Pub. Date: Jan. 9, 2020

(54) ELECTRONIC DEVICE AND METHOD FOR CONTROLLING OPERATION OF ELECTRONIC DEVICE

(71) Applicant: Samsung Electronics Co., Ltd., Gyeonggi-do (KR)

(72) Inventors: Gyuyeon JEON, Gyeonggi-do (KR); Wansang RYU, Gyeonggi-do (KR)

(21) Appl. No.: 16/495,526

(22) PCT Filed: Mar. 28, 2018
(86) PCT No.: PCT/KR2018/003668

§ 371 Date: Sep. 19, 2019

(30) Foreign Application Priority Data
Apr. 19, 2017 (KR) 10-2017-0050262

(51) Int. Cl. G05B 23/02; G06F 1/16; G06F 9/48; H04B 7/06

(52) U.S. Cl. CPC G05B 23/0235; H04B 7/0608; G06F 9/48; G06F 1/16

(57) ABSTRACT

Provided in various embodiments are an electronic device and a method for controlling the operation of the electronic device, the electronic device comprising: a housing; a conductive element positioned at a part of the housing or inside the housing; a sensing circuit electrically connected to the conductive element and sensing that an external object comes in contact therewith or is close thereto; and a processor, wherein the processor detects the generation of an interrupt, confirms whether the generated interrupt is a predetermined interrupt, and can reset the sensing circuit on the basis of the result produced by confirming whether the generated interrupt is a predetermined interrupt, and/or an output value of the sensing circuit. In addition, various embodiments are possible.

### TECHNICAL FIELD

Various embodiments of the disclosure relate to an electronic device and a method for controlling the operation of an electronic device.

### BACKGROUND ART

Various electronic devices, such as smart phones, tablet PCs, portable multimedia players (PMPs), personal digital assistants (PDAs), laptop personal computers (PCs), and wearable devices, are becoming popular.

Recently, various electronic devices have employed a sensor for detecting whether or not a user of the electronic device is holding the electronic device. The electronic device may provide various functions according to whether or not the user is holding the electronic device, which is detected by the sensor.

In particular, a function of adjusting the intensity of a radio wave output from the antenna of the electronic device according to the user's hold on the electronic device, a function of changing a user interface (UI) output to a display of an electronic device according to the hand holding the electronic device, and the like may be applied to the electronic device.

### DETAILED DESCRIPTION OF INVENTION

### Technical Problem

There are various methods in which a sensor determines whether or not an electronic device is held, and one of them is a method of detecting whether or not the user is holding the electronic device, based on the magnitude of capacitance that changes depending on the user's hold of the electronic device. The sensor may measure a physical quantity that changes according to the user's hold, and may then determine whether or not the user is holding the electronic device. If the measured physical quantity exceeds a threshold value, the sensor may determine that the user is holding the electronic device. However, in the case where an object attachable/detachable to/from the electronic device, such as a cover accessory, other than a part of the user's body approaches or comes into contact with the sensor, so that the physical quantity changes below or above a threshold value, the sensor may fail to recognize the user's hold, or may misrecognize that the user is holding the electronic device even though the electronic device is not held by the user.

Furthermore, in the case of adjusting the intensity of a radio wave output from the antenna according to the user's hold, a problem of malfunction of output may occur.

### Solution to Problem

An electronic device according to various embodiments of the disclosure may include: a housing; a conductive element positioned at a portion of the housing or inside the housing; a sensing circuit electrically connected to the conductive element and configured to sense contact or proximity of an external object; and a processor, wherein the processor is configured to detect the generation of an interrupt, identify whether or not the generated interrupt is a predetermined interrupt, and reset the sensing circuit, based on at least one of a result of identifying whether or not the generated interrupt is a predetermined interrupt or an output value of the sensing circuit.

A method for controlling the operation of an electronic device according to various embodiments of the disclosure may include: detecting the generation of an interrupt; determining whether or not the generated interrupt is a predetermined interrupt; and based on at least one of a result of determining whether or not the generated interrupt is the predetermined interrupt or an output value of a sensing circuit, which is electrically connected to a conductive element positioned at a portion of a housing or inside the housing and senses contact or proximity of an external object, resetting the sensing circuit.

### Advantageous Effects of Invention

An electronic device and a method for controlling the operation of an electronic device according to various embodiments of the disclosure reset a sensing circuit in such a manner that a reference value of the sensing circuit is changed if a predetermined interrupt corresponding to a situation in which a sensor needs to be reset is received, thereby preventing unnecessary operation of the sensing circuit.

Accordingly, it is possible to make it less likely that the malfunction in which the sensor fails to recognize the user's hold or misrecognize that the user is holding the electronic device even though the electronic device is not held by the user occurs.

### BRIEF DESCRIPTION OF DRAWINGS

FIG. 1 illustrates an electronic device in a network environment according to various embodiments of the disclosure.

FIG. 2 is a block diagram of an electronic device according to various embodiments of the disclosure.

FIG. 3 is a block diagram of an electronic device according to various embodiments of the disclosure.

FIGS. 4A and 4B are diagrams illustrating the appearance of an electronic device according to various embodiments of the disclosure.

FIG. 4C is a block diagram of a sensor using an antenna in an electronic device according to various embodiments of the disclosure.

FIG. 5 is a block diagram of an electronic device according to various embodiments of the disclosure.

FIGS. 6A and 6B are diagrams illustrating resetting of a sensing circuit using a hall sensor in an electronic device according to various embodiments of the disclosure.

FIGS. 7A and 7B are diagrams illustrating resetting of a sensing circuit using a value measured by means of an antenna in an electronic device according to various embodiments of the disclosure.

FIG. 8 is a diagram illustrating resetting of a sensing circuit according to a connection of an external electronic device in an electronic device according to various embodiments of the disclosure.

FIG. 9 is a flowchart illustrating a method of controlling the operation of an electronic device according to various embodiments of the disclosure.

FIG. 10 is a flowchart illustrating an operation of resetting a sensing circuit in a method of controlling the operation of an electronic device according to various embodiments of the disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness. The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

As used herein, the singular forms “a”, “an”, and “the” are intended to include the plural forms, including “at least one”, unless the content clearly indicates otherwise. “Or” means “and/or”. As used herein, the term “and/or” includes any and all combinations of one or more of the associated listed items. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that, although the terms “first”, “second”, “third”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element”, “component”, “region”, “layer” or “section” discussed below could be termed a second element, component, region, layer or section without departing from the teachings herein.

In this disclosure, an electronic device may be a device that involves a communication function. For example, an electronic device may be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, an electronic appcessory, or a smart watch). According to some embodiments, an electronic device may be a smart home appliance that involves a communication function. For example, an electronic device may be a TV, a DVD (Digital Video Disk) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame. According to some embodiments, an electronic device may be a medical device (e.g., MRA (Magnetic Resonance Angiography), MRI (Magnetic Resonance Imaging), CT (Computed Tomography), ultrasonography, etc.), a navigation device, a GPS (Global Positioning System) receiver, an EDR (Event Data Recorder), an FDR (Flight Data Recorder), a car infotainment device, electronic equipment for ship (e.g., a marine navigation system, a gyrocompass, etc.), avionics, security equipment, or an industrial or home robot. According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are exemplary only and not to be considered as a limitation of this disclosure.

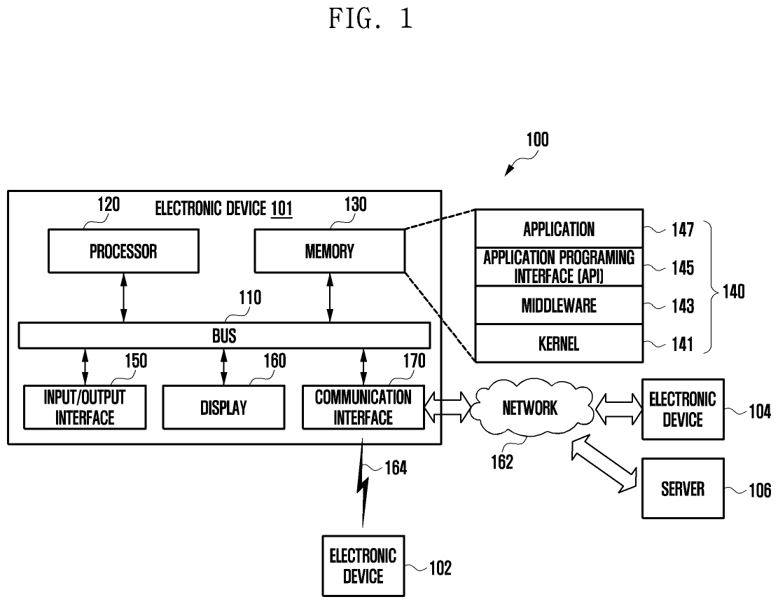

FIG. 1 illustrates a block diagram illustrating a configuration of an electronic device according to an embodiment of the present disclosure. Referring to FIG. 1, the electronic device 100 may include a bus 110, a processor 120, a memory 130, a user input 140, a display 150, a communication interface 160, and other similar and/or suitable components.

The bus 110 may be a circuit which interconnects the above-described elements and delivers a communication (e.g., a control message) between the above-described elements.

The processor 120 may receive commands from the above-described other elements (e.g., the memory 130, the user input 140, the display 150, the communication interface 160, etc.) through the bus 110, may interpret the received commands, and may execute calculation or data processing according to the interpreted commands.

The memory 130 may store commands or data received from the processor 120 or other elements (e.g., the user input 140, the display 150, the communication interface 160, etc.) or generated by the processor 120 or the other elements. The memory 130 may include programming modules, such as a kernel 131, middleware 132, an Application Programming Interface (API) 133, an application 134, and the like. Each of the above-described programming modules may be implemented in software, firmware, hardware, or a combination of two or more thereof. The kernel 131 may control or manage system resources (e.g., the bus 110, the processor 120, the memory 130, etc.) used to execute operations or functions implemented by other programming modules (e.g., the middleware 132, the API 133, and the application 134). Also, the kernel 131 may provide an interface capable of accessing and controlling or managing the individual elements of the electronic device 100 by using the middleware 132, the API 133, or the application 134. The middleware 132 may serve to go between the API 133 or the application 134 and the kernel 131 in such a manner that the API 133 or the application 134 communicates with the kernel 131 and exchanges data therewith. Also, in relation to work requests received from one or more applications 134 and/or the middleware 132, for example, may perform load balancing of the work requests by using a method of assigning a priority, in which system resources (e.g., the bus 110, the processor 120, the memory 130, etc.) of the electronic device 100 can be used, to at least one of the one or more applications 134.

The API 133 is an interface through which the application 134 is capable of controlling a function provided by the kernel 131 or the middleware 132, and may include, for example, at least one interface or function for file control, window control, image processing, character control, or the like. The user input 140, for example, may receive a command or data as input from a user, and may deliver the received command or data to the processor 120 or the memory 130 through the bus 110. The display 150 may display a video, an image, data, or the like to the user. The communication interface 160 may connect communication between another electronic device 102 and the electronic device 100. The communication interface 160 may support a predetermined short-range communication protocol (e.g., Wi-Fi, BlueTooth (BT), and near field communication (NFC)), or predetermined network communication 162 (e.g., the internet, a local area network (LAN), a wide area network (WAN), a telecommunication network, a cellular network, a satellite network, a plain old telephone service (POTS), or the like). Each of the electronic devices 102 and 104 may be a device which is identical (e.g., of an identical type) to or different (e.g., of a different type) from the electronic device 100. Further, the communication interface 160 may connect communication between a server 164 and the electronic device 100 via the network 162.

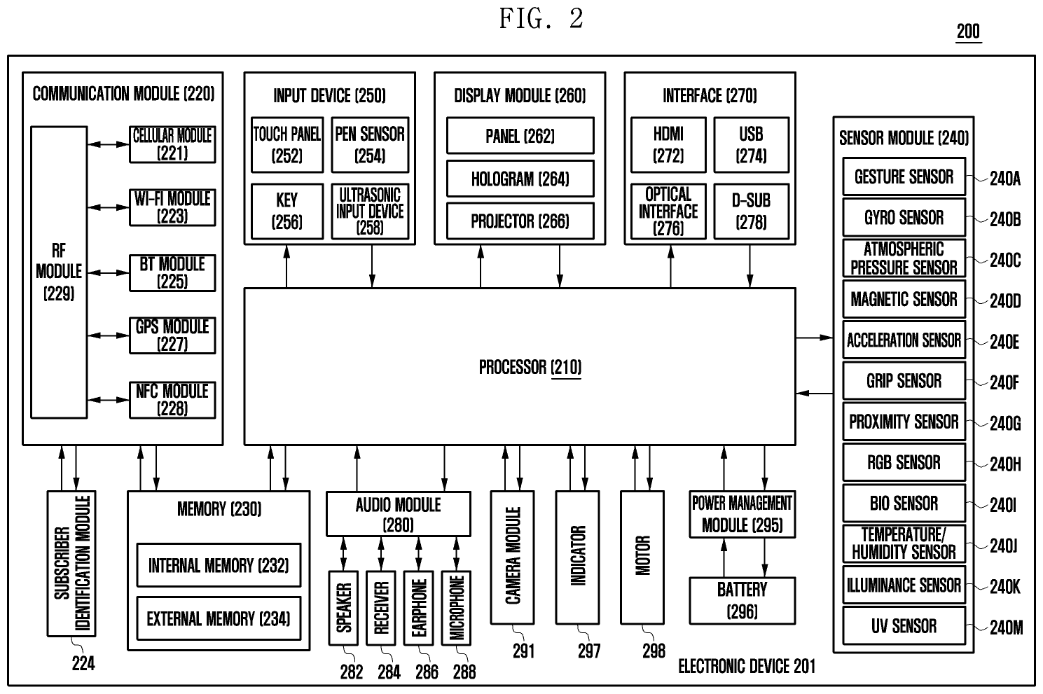

FIG. 2 illustrates a block diagram illustrating a configuration of hardware 200 according to an embodiment of the present disclosure.

The hardware 200 may be, for example, the electronic device 100 illustrated in FIG. 1. Referring to FIG. 2, the hardware 200 may include one or more processors 210, a Subscriber Identification Module (SIM) card 214, a memory 220, a communication interface 230, a sensor 240, a user input 250, a display 260, an interface 270, an audio coder/decoder (codec) 280, a camera 291, a power management 295, a battery 296, an indicator 297, a motor 298 and any other similar and/or suitable components.

The electronic device 201 according to various embodiments of the present disclosure is capable of including a housing, a groove formed inside an opening formed in part of the housing, an electrical connector placed inside the groove, a ground member placed inside the housing, and a switch for selecting at least one of a plurality of electrical paths based on a switch driving signal transmitted via at least one general purpose input/output pin. The processor 210 (e.g., the processor 120) may include one or more application processors (APs) 211, or one or more communication processors (CPs) 213. The processor 210 may be, for example, the processor 120 illustrated in FIG. 1. The AP 211 and the CP 213 are illustrated as being included in the processor 210 in FIG. 2, but may be included in different Integrated Circuit (IC) packages, respectively. According to an embodiment of the present disclosure, the AP 211 and the CP 213 may be included in one IC package. The AP 211 may execute an operating system (OS) or an application program, and thereby may control multiple hardware or software elements connected to the AP 211 and may perform processing of and arithmetic operations on various data including multimedia data. The AP 211 may be implemented by, for example, a system on chip (SoC). According to an embodiment of the present disclosure, the processor 210 may further include a graphical processing unit (GPU) (not illustrated).

The CP 213 may manage a data line and may convert a communication protocol in the case of communication between the electronic device (e.g., the electronic device 100) including the hardware 200 and different electronic devices connected to the electronic device through the network. The CP 213 may be implemented by, for example, a SoC. According to an embodiment of the present disclosure, the CP 213 may perform at least some of multimedia control functions. The CP 213, for example, may distinguish and authenticate a terminal in a communication network by using a subscriber identification module (e.g., the SIM card 214). Also, the CP 213 may provide the user with services, such as a voice telephony call, a video telephony call, a text message, packet data, and the like. Further, the CP 213 may control the transmission and reception of data by the communication interface230. In FIG. 2, the elements such as the CP 213, the power management 295, the memory 220, and the like are illustrated as elements separate from the AP 211. However, according to an embodiment of the present disclosure, the AP 211 may include at least some (e.g., the CP 213) of the above-described elements.

According to an embodiment of the present disclosure, the AP 211 or the CP 213 may load, to a volatile memory, a command or data received from at least one of a non-volatile memory and other elements connected to each of the AP 211 and the CP 213, and may process the loaded command or data. Also, the AP 211 or the CP 213 may store, in a non-volatile memory, data received from or generated by at least one of the other elements. The SIM card 214 may be a card implementing a subscriber identification module, and may be inserted into a slot formed in a particular portion of the electronic device 100. The SIM card 214 may include unique identification information (e.g., integrated circuit card identifier (ICCID)) or subscriber information (e.g., international mobile subscriber identity (IMSI)).

The memory 220 may include an internal memory 222 and an external memory 224. The memory 220 may be, for example, the memory 130 illustrated in FIG. 1. The internal memory 222 may include, for example, at least one of a volatile memory (e.g., a dynamic rAM (DRAM), a static rAM (SRAM), a synchronous dynamic RAM (SDRAM), etc.), and a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a Not AND (NAND) flash memory, a Not OR (NOR) flash memory, etc.). According to an embodiment of the present disclosure, the internal memory 222 may be in the form of a solid state drive (SSD). The external memory 224 may further include a flash drive, for example, a compact flash (CF), a Secure Digital (SD), a micro-secure digital (Micro-SD), a mini-secure digital (Mini-SD), an extreme Digital (xD), a memory stick, or the like.

In various embodiments of the present disclosure, the memory 230 stores instructions which enable the processor 210 to: detect an external electrical connector inserted into the electrical connector; and select at least one of a plurality of electrical paths between the RF interface and the ground member, in response to at least part of the inserted external electrical connector. In various embodiments of the present disclosure, the memory 230 stores instructions which enable the processor 210 to select: a first path of the plurality of electrical paths, when the external electrical connector is not inserted to the electrical connector; and a second path of the plurality of electrical paths, when the external electrical connector is inserted to the electrical connector. In various embodiments of the present disclosure, the memory 230 stores instructions which enable the processor 210 to switch a first electrical path of the plurality of electrical paths to a second electrical path, when the signals of the frequency are transmitted/received. In various embodiments of the present disclosure, the memory 230 stores a switching table containing information regarding a switch driving signal corresponding to at least one external electrical connector, according to frequency bands. In various embodiments of the present disclosure, the memory 230 stores the instructions which enable the processor 210 to: create a switch driving signal corresponding to the detected external electrical connector, based on a stored switching table; and select at least one of the plurality of electrical paths, based on the switch driving signal transmitted to the switch via at least one general purpose input/output pin.

The sensor 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a red, green and blue (RGB) sensor 240H, a biometric sensor 2401, a temperature/humidity sensor 240J, an illuminance sensor 240K, and a ultra violet (UV) sensor 240M. The sensor 240 may measure a physical quantity or may sense an operating state of the electronic device 100, and may convert the measured or sensed information to an electrical signal. Additionally/alternatively, the sensor 240 may include, for example, an e-nose sensor (not illustrated), an electromyography (EMG) sensor (not illustrated), an electroencephalogram (EEG) sensor (not illustrated), an electrocardiogram (ECG) sensor (not illustrated), a fingerprint sensor (not illustrated), and the like. Additionally or alternatively, the sensor 240 may include, for example, an E-nose sensor (not illustrated), an EMG sensor (not illustrated), an EEG sensor (not illustrated), an ECG sensor (not illustrated), a fingerprint sensor, and the like. The sensor 240 may further include a control circuit (not illustrated) for controlling one or more sensors included therein.

The user input 250 may include a touch panel 252, a pen sensor 254 (e.g., a digital pen sensor), keys 256, and an ultrasonic input unit 258. The user input 250 may be, for example, the user input 140 illustrated in FIG. 1. The touch panel 252 may recognize a touch input in at least one of, for example, a capacitive scheme, a resistive scheme, an infrared scheme, and an acoustic wave scheme. Also, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user. The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the hardware 200 may receive a user input from an external device (e.g., a network, a computer, or a server), which is connected to the communication interface 230, through the communication interface 230. The display 260 may include a panel 262 or a hologram 264. The display 260 may be, for example, the display 150 illustrated in FIG. 1. The panel 262 may be, for example, a liquid crystal display (LCD) and an active matrix organic light emitting diode (AM-OLED) display, and the like. The panel 262 may be implemented so as to be, for example, flexible, transparent, or wearable. The panel 262 may include the touch panel 252 and one module. The hologram 264 may display a three-dimensional image in the air by using interference of light. According to an embodiment of the present disclosure, the display 260 may further include a control circuit for controlling the panel 262 or the hologram 264.

The interface 270 may include, for example, a high-definition Multimedia Interface (HDMI) 272, a universal serial bus (USB) 274, a projector 276, and a D-subminiature (D-sub) 278. Additionally or alternatively, the interface 270 may include, for example, SD/multi-media card (MMC) (not illustrated) or infrared data association (IrDA) (not illustrated). The audio codec 280 may bidirectionally convert between a voice and an electrical signal. The audio codec 280 may convert voice information, which is input to or output from the audio codec 280, through, for example, a speaker 282, a receiver 284, an earphone 286, the microphone 288 or the like.

The camera 291 may capture an image and a moving image. According to an embodiment, the camera 291 may include one or more image sensors (e.g., a front lens or a back lens), an image signal processor (ISP) (not illustrated), and a flash LED (not illustrated).

The power management 295 may manage power of the hardware 200. Although not illustrated, the power management 295 may include, for example, a power management integrated circuit (PMIC), a charger integrated circuit (IC), or a battery fuel gauge. The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, etc.) for wireless charging may be added in order to perform the wireless charging. The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware 200 or a part (e.g., the AP 211) of the hardware 200, for example, a booting state, a message state, a charging state and the like. The motor 298 may convert an electrical signal into a mechanical vibration. The processor 210 may control the sensor 240.

Although not illustrated, the hardware 200 may include a processing unit (e.g., a GPU) for supporting a module TV. The processing unit for supporting a module TV may process media data according to standards such as, for example, digital multimedia broadcasting (DMB), digital video broadcasting (DVB), media flow, and the like. Each of the above-described elements of the hardware 200 according to an embodiment of the present disclosure may include one or more components, and the name of the relevant element may change depending on the type of electronic device. The hardware 200 according to an embodiment of the present disclosure may include at least one of the above-described elements. Some of the above-described elements may be omitted from the hardware 200, or the hardware 200 may further include additional elements. Also, some of the elements of the hardware 200 according to an embodiment of the present disclosure may be combined into one entity, which may perform functions identical to those of the relevant elements before the combination.

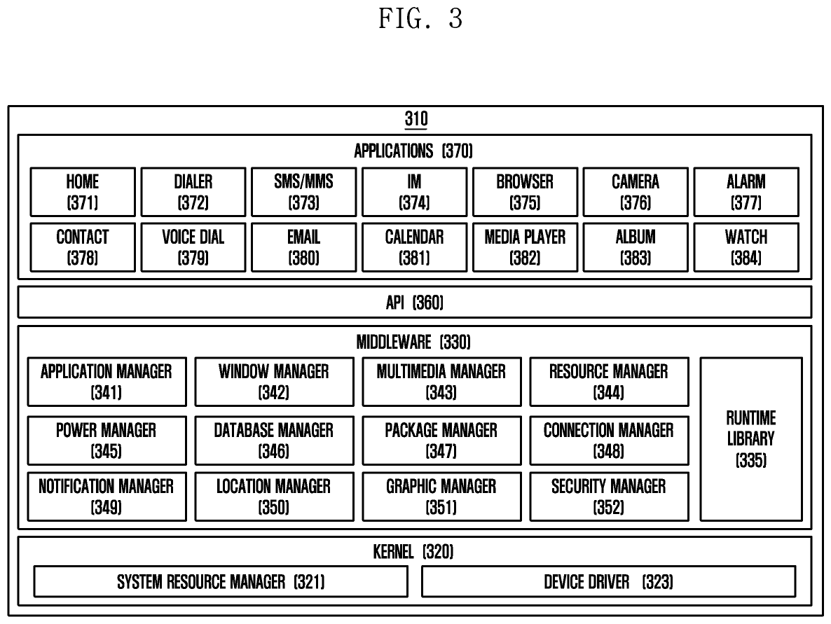

FIG. 3 illustrates a block diagram illustrating a configuration of a programming module 300 according to an embodiment of the present disclosure.

The programming module 300 may be included (or stored) in the electronic device 100 (e.g., the memory 130) or may be included (or stored) in the electronic device 200 (e.g., the memory 230) illustrated in FIG. 1. At least a part of the programming module 300 may be implemented in software, firmware, hardware, or a combination of two or more thereof. The programming module 300 may be implemented in hardware (e.g., the hardware 200), and may include an OS controlling resources related to an electronic device (e.g., the electronic device 100) and/or various applications (e.g., an application 370) executed in the OS. For example, the OS may be Android, iOS, Windows, Symbian, Tizen, Bada, and the like. Referring to FIG. 3, the programming module 300 may include a kernel 310, a middleware 330, an API 360, and/or the application 370.

The kernel 310 (e.g., the kernel 131) may include a system resource manager 311 and/or a device driver 312. The system resource manager 311 may include, for example, a process manager (not illustrated), a memory manager (not illustrated), and a file system manager (not illustrated). The system resource manager 311 may perform the control, allocation, recovery, and/or the like of system resources. The device driver 312 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 312 may include an inter-process communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager. The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like. The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370. The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file. The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device. The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In the case of Android or iOS, for example, one API set may be provided to each platform. In the case of Tizen, for example, two or more API sets may be provided to each platform. The applications 370 (e.g., the applications 134) may include, for example, a preloaded application and/or a third party application. The applications 370 (e.g., the applications 134) may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application. At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 220. At least a part of the programming module 300 may be implemented (e.g., executed) by, for example, the one or more processors 210. At least a part of the programming module 300 may include, for example, a module, a program, a routine, a set of instructions, and/or a process for performing one or more functions. Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. Also, some of the operations may be omitted, or other operations may be added to the operations.

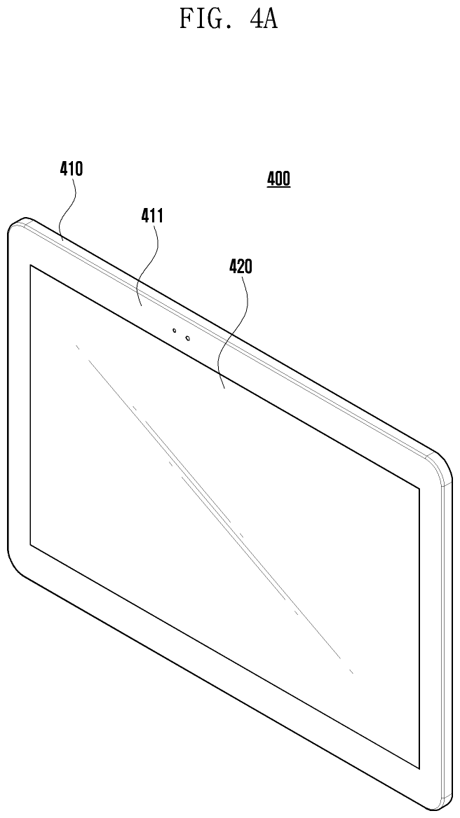

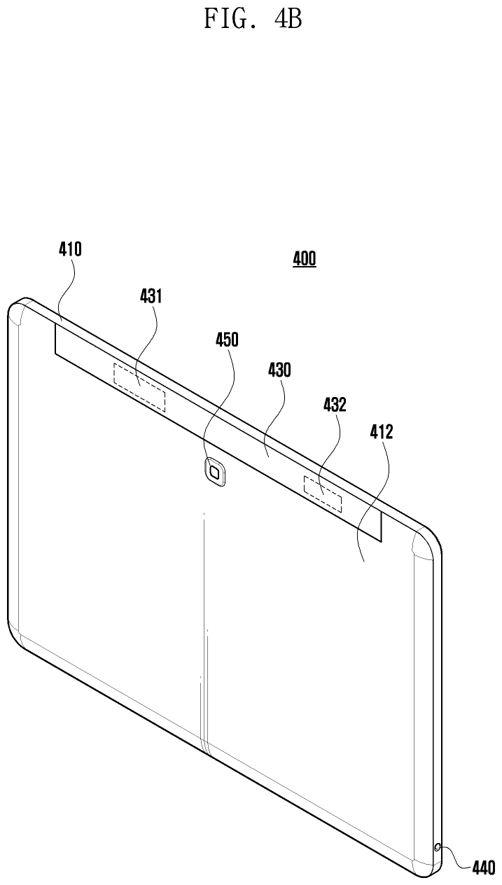

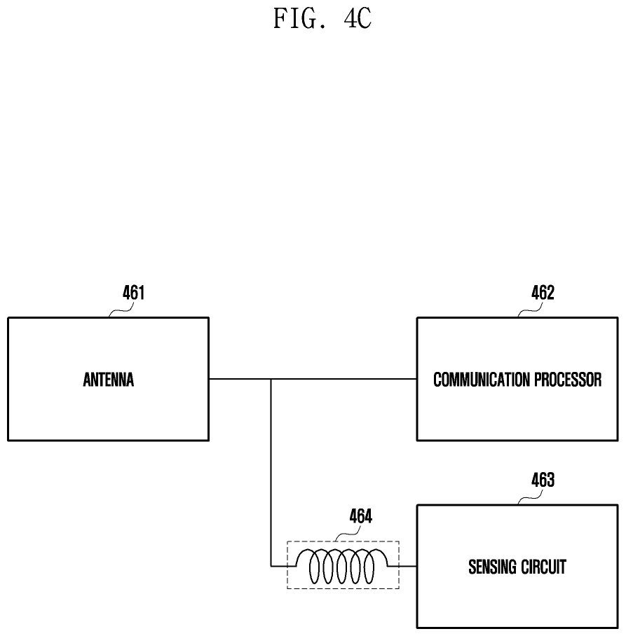

FIGS. 4A and 4B are diagrams illustrating the appearance of an electronic device according to various embodiments of the disclosure.

FIG. 4A illustrates an electronic device 400 having a surface 411, through which a display 420 is exposed, among a plurality of surfaces constituting a housing 410 of the electronic device 400.

The housing 410 may refer to a frame that accommodates components (e.g., a grip sensor 510, a processor 520, and the like) of the electronic device 400. According to an embodiment, the housing 410 may be made of a conductive material (e.g., a metal material), but is not limited to a specific material. The conductive material may be electrically connected to the grip sensor 240F. It is possible to sense whether or not the user is holding the electronic device through the conductive material. According to various embodiments of the disclosure, a surface 411 of the electronic device 400 illustrated in FIG. 4A may denote a front surface of the electronic device.

The display 420 may be a component that outputs an image. According to various embodiments of the disclosure, the display 420 may support a touch input on the display 420. To this end, the display 420 may further include a touch panel. The electronic device 400 may support input by means of various input devices, and may further include a digitizer panel for supporting input of a stylus pen.

FIG. 4B illustrates an electronic device 400 having a surface 412 opposite the surface through which the display 420 is exposed (e.g., the surface illustrated in FIG. 4A), among the plurality of surfaces constituting the housing 410 of the electronic device 400. According to various embodiments of the disclosure, a surface 412 of the electronic device 400 illustrated in FIG. 4B may be a rear surface of the electronic device.

According to various embodiments of the disclosure, like the front surface 411, the rear surface 412 of the electronic device 400 may be made of a conductive material (e.g., a metal material). In the case where the rear surface of the electronic device 400 is made of a conductive material, the area 430 in which the antenna 431 is disposed may be made of a non-conductive material (e.g., a plastic material) in order for the antenna 431 included in the electronic device 400 to radiate radio waves. Referring to FIG. 4B, the area 430 in which the antenna 431 is disposed is separated from the rear surface 412 by a boundary line. The boundary line may be produced by the difference between the material constituting the rear surface 412 and the material constituting the area 430 in which the antenna 431 is disposed. The boundary line may be omitted depending on the designer's intention or materials. According to various embodiments of the disclosure, the rear surface 412 of the electronic device 400 may be made of a non-conductive material (e.g., a plastic material or the like). The rear surface of the electronic device 400 may include a conductive element 431 for determining whether or not an external object (e.g., a user or a conductive material) is nereby. For example, the conductive element 431 may be configured as an antenna. Alternatively, the conductive element 431 may be made of a conductive material having a predetermined area, and may be positioned inside the housing. The area 430 in which the conductive element 431 is disposed is not limited to a specific position. A plurality of conductive elements may be provided.

According to various embodiments of the disclosure, the area 430 in which the antenna 431 is disposed may be provided at the upper end of the rear surface 412 of the electronic device 400. However, the area 430 in which the antenna 431 is disposed is not limited to a specific position. For example, the antenna 431 may be provided on the side of the electronic device 400, at the lower portion of the rear surface 412 thereof, or on the front surface 411 thereof.

According to various embodiments of the disclosure, the antenna 431 may be electrically connected to the sensing circuit 463. The antenna 431 may be electrically connected to the sensing circuit 463, and may be used to sense whether or not the user is holding the electronic device 400. This will be described later with reference to FIG. 4C.

According to various embodiments of the disclosure, the electronic device 400 may include a plurality of sensors (e.g., 240). For example, one of the plurality of sensors may be a hall sensor 432. The hall sensor 432 may be arranged inside the area 430 in which the antenna 431 is disposed.

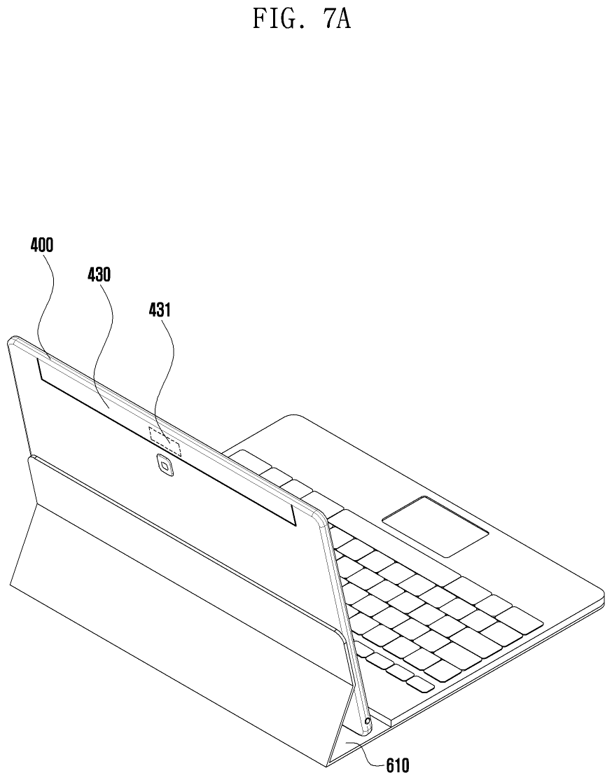

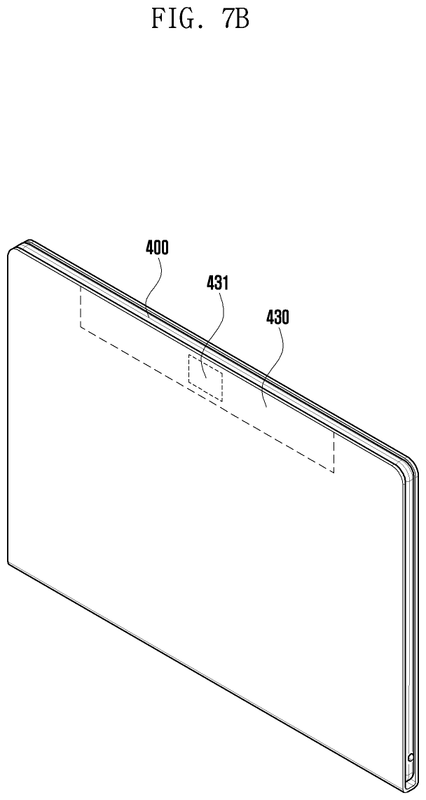

The hall sensor 432 may be a sensor that detects whether or not a specific object is positioned within a predetermined distance using the Hall effect in which, if a magnetic field is applied to a conductor through which a current flows, a voltage is generated in a direction perpendicular to the current and the magnetic field. According to various embodiments of the disclosure, the electronic device 400 may determine the attached/detached state of the cover accessory using the hall sensor 432. This will be described with reference to FIGS. 7A and 7B.

The electronic device 400 according to various embodiments of the disclosure may be connected to various external electronic devices through wired or wireless communication. The electronic device 400 may further include a connector 440 for connection with an external electronic device. According to various embodiments of the disclosure, the connector 440 may be any of various connectors such as a connector defined in a universal series bus (USB) type, a power connector, a connector for a speaker (or earphones), and the like.

The electronic device 400 according to various embodiments of the disclosure may further include a camera, and a lens 450 constituting the camera may be disposed on the rear surface 412 of the electronic device.

FIG. 4C is a diagram illustrating a sensing circuit using an antenna 461 in an electronic device 400 according to various embodiments of the disclosure.

The antenna 461 may radiate a signal transmitted from a communication processor 462 (e.g., the communication module 220). According to various embodiments of the disclosure, the antenna 461 may be a conductive antenna made of a metal material. According to various embodiments of the disclosure, the antenna 461 may be an antenna that outputs signals corresponding to various wireless communication standards. For example, the antenna 461 may correspond to an antenna that radiates various signals, such as an antenna radiating a signal using a Wi-Fi communication standard, an antenna radiating a signal using a long-term evolution (LTE) communication standard, an antenna radiating a near-field communication (NFC) signal, an antenna radiating a magnetic secure transmission (MST) signal, and the like.

The communication processor 462 may process a signal to be transmitted to the outside, and may transmit a signal to be transmitted to the antenna 461. To this end, the antenna 461 and the communication processor 462 may be electrically connected to each other.

According to various embodiments of the disclosure, the sensing circuit 463 may detect that an unspecified object approaches (or comes into contact with) the electronic device 400. To this end, the sensing circuit 463 may detect a change in the physical quantity (e.g., a current flowing from the antenna 461 to the sensing circuit 463, capacitance between an object and the antenna 461, or the like) generated by an object (e.g., a human hand, an accessory device, etc.) in contact with (or in proximity to) the antenna 461. The sensing circuit 463 may detect whether or not the object comes into contact with (or is in proximity to) the electronic device 400, based on a change in the physical quantity generated by the contact of the object.

To this end, the sensing circuit 463 may be electrically connected to the antenna 461. According to various embodiments of the disclosure, the sensing circuit 463 may be electrically connected to the antenna 461 through a circuit 464 using an inductor in order to prevent reduction in the performance of the antenna 461.

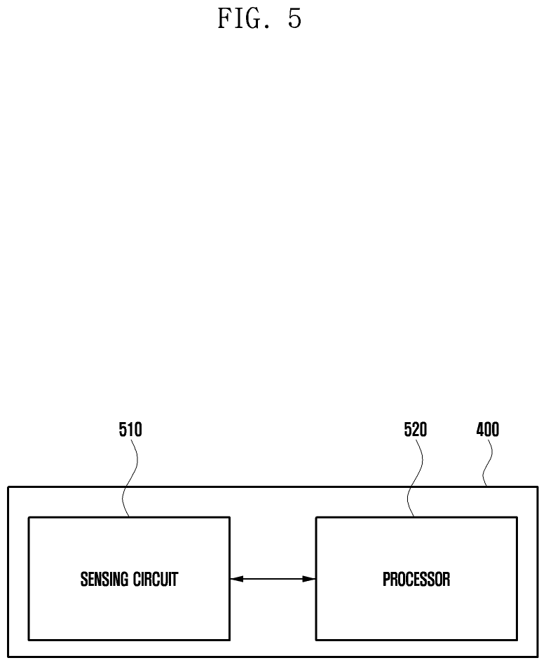

FIG. 5 is a block diagram of an electronic device according to various embodiments of the disclosure.

An electronic device 400 according to various embodiments of the disclosure may include a sensing circuit 510 and a processor 520.

The sensing circuit 510 may be connected to a conductive element 431 positioned at a portion of the housing or inside the housing. According to various embodiments of the disclosure, the conductive element 431 may be a conductive pattern implemented in a specific shape. The conductive pattern may be an antenna. It is possible to sense whether or not an external object (e.g., an accessory device, a user's body, etc.) comes into contact with (or is in proximity to) a predetermined area of the housing 410 of the electronic device 400. According to various embodiments of the disclosure, in the case of using the sensing circuit 510 to which the structure described with reference to FIG. 4C is applied, the predetermined area may include the area 431 in which the antenna 461 is disposed. According to another embodiment of the disclosure, the sensing circuit 510 may be connected to the conductive element 431, and may sense whether or not an external object (e.g., a cover accessory, a user's body, etc.) comes into contact with (or is in proximity to) a predetermined area of the housing 410 of the electronic device 400.

The processor 520 may detect the generation of an interrupt.

According to various embodiments of the disclosure, the interrupt may refer to a signal generated from any of various components (e.g., the connector 440, the sensor 432, and the like) of the electronic device 400.

According to various embodiments of the disclosure, the interrupt may refer to a signal corresponding to the state measured by the sensor 432 (e.g., the state in which the accessory device approaches the sensor 432).

According to various embodiments of the disclosure, the interrupt may refer to a signal generated in response to a connection of an external electronic device to the connector 440.

The processor 520 may identify whether or not the generated interrupt is a predetermined interrupt. According to various embodiments of the disclosure, the predetermined interrupt may be an interrupt corresponding to various conditions that require an operation of resetting the sensing circuit 510. Details related to the resetting of the sensing circuit 510 will be described in detail below.

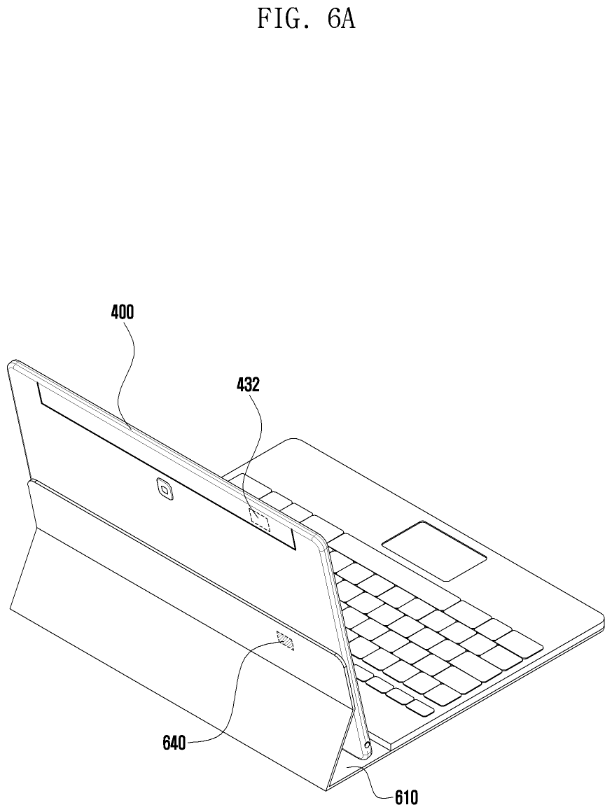

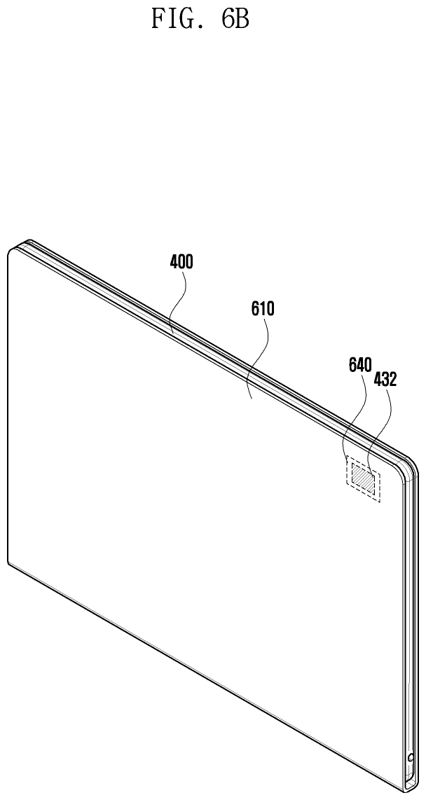

According to various embodiments of the disclosure, if the signal measured by the sensor 432 corresponds to the state in which a specific object (e.g., a magnetic material such as a magnet) is located within a predetermined distance from the sensor 432, the predetermined interrupt may correspond to the signal output from the sensor 432. For example, if an accessory device that may be attached to at least a portion of one surface of the housing 410 of the electronic device 400 includes a magnetic material, the sensor 432 may sense whether the accessory device is attached to or detached from the portion of the one surface of the housing 410. Details of the above and detailed reasons for resetting the sensing circuit 510 will be described with reference to FIGS. 6A and 6B.

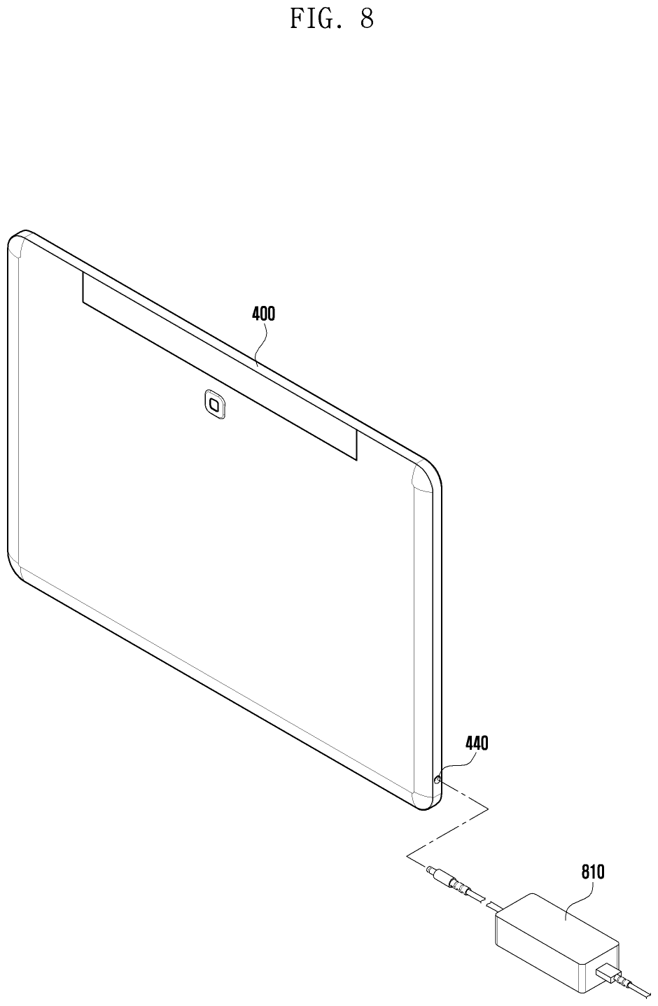

According to various embodiments of the disclosure, the predetermined interrupt may be an interrupt that is generated when a specific external electronic device (e.g., an external electronic device or an adapter for supplying power to the electronic device 400) connects to the connector 440. Details of the above and detailed reasons for resetting the sensing circuit 510 will be described with reference to FIG. 8.

The processor 520 may reset the sensing circuit 510, based on at least one of a result of identifying that the generated interrupt is a predetermined interrupt or an output value of the sensing circuit 510.

According to various embodiments of the disclosure, the processor 520 may reset the sensing circuit 510 if an output value of the sensing circuit 510 exceeds a first threshold value. For example, if the output value of the sensing circuit 510 is maintained to be a value between a first threshold value and a third threshold value greater than the first threshold value for a predetermined period of time or more, the processor 520 may reset the sensing circuit 510.

According to another embodiment of the disclosure, if an absolute value of the difference between an output value of the sensing circuit 510 and a reference value exceeds a reference amount of change, the processor 520 may reset the sensing circuit 510. For example, if an output value is greater than a reference value, and if a value obtained by subtracting the reference value from the output value exceeds a reference amount of change, the sensing circuit 510 may be reset. As another example, if an output value is lower than a reference value, and if a value obtained by subtracting the output value from the reference value exceeds a reference amount of change, the sensing circuit 510 may be reset. According to various embodiments of the disclosure, resetting the sensing circuit 510 may be resetting the reference value with a physical quantity (e.g., capacitance or the like) (hereinafter, referred to as a “measurement value”) measured by the sensing circuit 510 at the time at which an interrupt is generated.

According to various embodiments of the disclosure, resetting the sensing circuit 510 may be resetting a second threshold value of the sensing circuit 510. If a value output from the sensing circuit 510 exceeds a second threshold value, the processor 520 may perform various operations (e.g., may control the output of the antenna).

According to various embodiments of the disclosure, a first threshold value may be used to sense whether or not an accessory device is attached, and a second threshold value may be used to sense whether or not the electronic device 400 is held by the user.

According to various embodiments of the disclosure, a third threshold value may be greater than the first threshold value and less than the second threshold value. The second threshold value may be greater than the first threshold value.

According to various embodiments of the disclosure, the third threshold value may be less than the first threshold value but greater than the second threshold value. The second threshold value may be less than the first threshold value.

Resetting the sensing circuit 510 may be intended to prevent an unnecessary operation or malfunction due to a sensing result of the sensing circuit 510.

According to various embodiments of the disclosure, if the difference between a measurement value measured by the sensing circuit 510 and a reference value exceeds the second threshold value, the processor 520 may perform an operation of adjusting the output of an antenna (not shown). This may be intended to prevent the user of the electronic device 400 from being exposed to electromagnetic waves output from the antenna (not shown). For example, the processor 520 may perform an operation of adjusting the output of the antenna 431 in response to the operation in which the sensing circuit 510 detects a change in the physical quantity due to the user's hold. As another example, if the user is holding the electronic device 400 in the state in which an external object (e.g., a cover accessory device) is attached to the electronic device 400, the physical quantity may not exceed the second threshold value. In this case, the processor 520 may not adjust the output of the antenna 431 even though the user is holding the electronic device 400. That is, there may be malfunction in which the output of the antenna is not adjusted even though the sensing circuit 510 senses the contact of the user.

As another example, the processor 520 may identify a holding area, and may perform changing a UI in response to the operation in which the sensing circuit 510 detects a change in the physical quantity corresponding to a user's hold. There may be malfunction in which the UI is not changed even though the user is holding the electronic device 400.

The processor 520 of the electronic device 400 according to various embodiments of the disclosure may reset the sensing circuit 510 in order to prevent malfunction of the sensing circuit 510.

According to various embodiments of the disclosure, if a predetermined interrupt corresponding to the state in which a specific object (e.g., a magnetic material such as a magnet) is located within a predetermined distance from the sensor 432 is detected, the processor 520 may reset, as a reference value, the measurement value of the sensing circuit 510 corresponding to the time at which the interrupt is generated.

According to various embodiments of the disclosure, the processor 520 may determine whether or not a value measured by the sensing circuit 510 exceeds (or is equal to or greater than) a first threshold value, or may determine whether or not the difference between a value measured by the sensing circuit 510 and a reference value exceeds (or is equal to or greater than) a reference amount of change.

If a value measured by the sensing circuit 510 exceeds a first threshold value, or if the difference between a value measured by the sensing circuit 510 and a reference value exceeds a reference amount of change, the processor 520 may reset the sensing circuit 510. If the difference between a value measured by the sensing circuit 510 and a reference value does not exceed a reference amount of change, the processor 520 may not reset the sensing circuit 520, and may maintained the existing reference value. According to various embodiments of the disclosure, the processor 520 may count the number of times the sensing circuit 510 is reset. The processor 520 may determine whether or not the number of times the sensing circuit 510 is reset exceeds (or is equal to or greater than) a predetermined number, and, if the number of times the sensing circuit 510 is reset exceeds the predetermined number, may adjust the magnitude of the second threshold value. For example, if the number of times the sensing circuit 510 is reset exceeds the predetermined number, the processor 520 may increase the second threshold value. For example, assuming that a plurality of accessory devices is sequentially attached to the electronic device 400, whenever respective ones of the plurality of accessory devices are sequentially attached to the electronic device, the value measured by the sensing circuit 510 may exceed the first threshold value. In the case where the plurality of accessory devices is attached to the electronic device, the second threshold value may be adjusted to be continuously reduced. As the second threshold value is reduced, even if the user does not hold the electronic device, there may be malfunction in which the sensing circuit 510 senses a user's hold due to noise or the like. Accordingly, if the number of times the sensing circuit 510 is reset exceeds a predetermined number, the processor 520 according to various embodiments of the disclosure may adjust the magnitude of the second threshold value. According to various embodiments of the disclosure, the processor 520 may reset the sensing circuit 510 in response to an interrupt generated by a connection of a specific external electronic device (e.g., an external electronic device for supplying power to the electronic device 400) to the connector 440.

FIGS. 6A and 6B are diagrams illustrating setting of a sensing circuit using a sensor in an electronic device according to various embodiments of the disclosure.

FIG. 6A illustrates an accessory device that is attached to a portion of one surface of the electronic device 400 (e.g., the surface 412 shown in FIG. 4B). The state of the electronic device illustrated in FIG. 6A may be defined as a stand mode in which the rear surface thereof is partially covered by a cover while the electronic device 400 is standing. The cover accessory 610 is attached to a portion below the sensor disposed in one surface 412 of the electronic device 400. Referring to FIG. 6A, it can be seen that the accessory device 610 does not cover the area in which the sensor 432 is disposed. According to various embodiments of the disclosure, the sensor may be disposed in another area 620 of the electronic device, thereby sensing the stand mode of the electronic device 400.

According to various embodiments of the disclosure, the sensor 432 of the electronic device 400 may sense whether or not a magnet 640 of the accessory device 610 is positioned within a predetermined distance. FIG. 6A illustrates the state in which the magnet 640 of the cover accessory device 610 is not positioned within a predetermined distance from the sensor 432 of the electronic device 400. This may correspond to the state in which the processor 520 does not detect an interrupt.

FIG. 6B illustrates a cover accessory device 610 that is attached to one surface of the electronic device 400 (e.g., the surface 412 shown in FIG. 4B). The state of the electronic device illustrated in FIG. 6A may be defined as a cover mode in which a rear surface thereof is covered by a cover. The electronic device 400 according to various embodiments of the disclosure may identify the stand mode or the cover mode according to the position sensed by the sensor 432. In particular, referring to FIG. 6B, it can be seen that the accessory device 610 covers the area in which the sensor 432 is disposed in one surface 412 of the electronic device. Referring to FIG. 6B, it is assumed that the magnet 640 of the accessory device 610 is positioned within a predetermined distance from the sensor 432 of the electronic device 400. According to the above assumption, the processor 520 may detect an interrupt, and may identify that the detected interrupt is a predetermined interrupt. The processor 520 may reset the sensing circuit 510 in response to identifying that the detected interrupt is a predetermined interrupt. As described above, the processor 520 may set, as a reference value, the physical quantity measured by the sensing circuit 510 when the magnet 640 is positioned within a predetermined distance from the sensor 432 of the electronic device 400.

On the other hand, it is assumed that the accessory device 610 has changed from the state of FIG. 6B to the state of FIG. 6A. The processor 520 may identify the physical quantity measured by the sensing circuit 510, may identify that the magnet 640 is not positioned within a predetermined distance from the sensor 432 of the electronic device 400, and may not reset the sensing circuit 510.

According to various embodiments of the disclosure, the sensor 432 may be implemented as a hall sensor that senses magnetic force.

FIGS. 7A and 7B are diagrams illustrating resetting of a sensing circuit using a value measured by means of an antenna in an electronic device according to various embodiments of the disclosure.

FIG. 7A illustrates an accessory device 610 that is attached to a portion of one surface of the electronic device 400 (e.g., the surface 412 shown in FIG. 4B). Referring to FIG. 7A, the electronic device 400 may include a conductive element 431. The conductive element 431 may be implemented as a conductive pattern implemented in a specific shape. The conductive pattern 431 may refer to an antenna. For example, the electronic device 410 may identify that the accessory device 610 does not cover the area in which the conductive element 431 is disposed. The sensing circuit 510 may operate using the conductive element 431 as described in FIG. 4C above. According to the state illustrated in FIG. 7A (e.g., the state in which the accessory device 610 does not cover the conductive element 431), the measurement value measured by the sensing circuit 510 may correspond to a reference value of the sensing circuit.

According to various embodiments of the disclosure, a plurality of conductive elements 431 may be provided in an area of the electronic device 400 (e.g., on the side surface at the upper end of the electronic device 400). For example, it is possible to identify whether or not the accessory device 610 covers the upper end of the electronic device 400 (e.g., the area 430 in which the conductive pattern 431 is disposed) using the plurality of conductive elements 431.

FIG. 7B illustrates an accessory device 610 that is attached to one surface of the electronic device 400 (e.g., the surface 412 shown in FIG. 4B). Referring to FIG. 7B, it can be seen that the accessory device 610 covers the area in which the conductive element 431 is disposed. The measurement value measured by the sensing circuit 510 in the state shown in FIG. 7B (in the state in which the accessory device 610 is in contact with one surface of the housing 410) is defined as a first measurement value. In addition, the measurement value measured by the sensing circuit 510 in the state in which a part of the user's body (e.g., a user's hand) comes into contact with (or is in proximity to) the area in which the conductive pattern 431 is disposed is defined as a second measurement value.

Table 1 below shows an embodiment of a reference value, a second measurement value, a third measurement value, and a threshold value.

TABLE 1

| | Measurement values |
|---|---|
| First threshold value | 93 |
| Second threshold value | 1300 |
| Reference value | 10 |
| First measurement value | 170 |
| (contact with cover) | |
| Second measurement value | 1600 |
| (contact with user's body) | |

Referring to Table 1, it can be seen that the difference between the first measurement value and the reference value is “160”, which exceeds the first threshold value “93” but does not exceed the second threshold value “1300”. The difference between the second measurement value and the reference value is “1590”, which exceeds the first threshold value “93” and the second threshold value “1300”. That is, it can be confirmed that the differences between the respective ones of the first and second measurement values and the reference value exceed the threshold value.

In addition, it can be confirmed that the first measurement value “170” exceeds the first threshold value “93” but does not exceed the second threshold value “1300”. It can be seen that the second measurement value “1600” exceeds both the first threshold value “93” and the second threshold value “1300”.

As described above, the sensing circuit 510 may measure a physical quantity generated when the user's body comes into contact with the electronic device 400. If the measurement value exceeds the second threshold value, the processor 520 may adjust the intensity of a radio wave output from the antenna. However, even in the case the cover comes into contact with the electronic device, the measurement value may exceed the second threshold value, similarly to the case in which the user's body comes into contact with the electronic device, so that the processor 520 unnecessarily adjusts the intensity of a radio wave. In order to solve the above problem, the second threshold value may be modified in the electronic device 400 according to various embodiments of the disclosure. For example, the second threshold may be increased.

In an electronic device 400 according to various embodiments of the disclosure, the processor 520 may check whether or not the measurement value measured by the sensing circuit 510 exceeds the first threshold value. If the measurement value exceeds the first threshold value, the processor 520 may identify whether or not the measurement value is maintained for a predetermined period of time or more. If the measurement value is maintained to be greater than the first threshold value and less than the third threshold for a predetermined period of time or more, the processor 520 may reset the sensing circuit 510.

In an electronic device 400 according to another embodiment of the disclosure, the processor 520 may identify whether or not the difference between the measurement value measured by the sensing circuit 510 and a reference value exceeds a predetermined value (e.g., a reference difference value). If the difference between the measurement value and the reference value exceeds a predetermined value (e.g., a reference amount of change), the processor 520 may identify whether or not the measurement value is maintained for a predetermined period of time or more. According to another embodiment, the processor 520 may also identify whether or not the measurement value is maintained within a predetermined range for a predetermined period of time or more.

The processor 520 according to various embodiments of the disclosure may compare the difference value between the measurement value and the reference value with a predetermined value (e.g., a reference amount of change), and if the difference value exceeds a reference amount of change and if the measurement value is maintained for a predetermined period time or more, the processor 520 may reset the sensing circuit 510.

The processor 520 may reset the sensing circuit 510 in response to the time at which an interrupt is generated. Referring to Table 1, it can be seen that the measurement value of the sensing circuit 510 corresponding to the time at which an interrupt is generated is “170”, which is the first measurement value. The processor 520 may reset the reference value to “170”. If an absolute value of the difference between the measurement value and the newly set reference value “170” exceeds (or is equal to or greater than) a reference amount of change, the processor 520 may determine that an interrupt has been generated, and may repeat the operations described above.

If the first measurement value “170” exceeds the first threshold value, and if the exceeding state is maintained for a predetermined period of time or more, the processor 520 according to various embodiments of the disclosure may also adjust the second threshold value. For example, the processor 520 may reduce the second threshold value. This is intended to prevent the phenomenon in which the sensing circuit fails to sense a user's hold on the electronic device 400 by a user's body (e.g., a hand or the like) due to an external object (e.g., a cover accessory or the like) attached to the electronic device 400.

If the value measured by the sensing circuit 510 (or an absolute value of the difference between the measurement value and the reference value) exceeds a predetermined value (this may be a value other than the threshold value), the processor 520 according to various embodiments of the disclosure may execute various functions, instead of resetting the sensing circuit 510. For example, the processor 520 may perform control so as to reduce the intensity of a radio wave radiated from the antenna. As another example, the processor 520 may control the display so as to output another type of UI.

The resetting of the sensing circuit using one antenna has been described with reference to FIGS. 7A and 7B. However, the disclosure may perform resetting the sensing circuit without being limited to a specific number of antennas. For example, resetting the sensing circuit using two antennas (e.g., an antenna used for a Wi-Fi signal and an antenna used for an LTE signal) may also be performed in the same manner as the description above.

FIG. 8 is a diagram illustrating resetting of a sensing circuit according to a connection of an external electronic device in an electronic device according to various embodiments of the disclosure.

Referring to FIG. 8, an electronic device 400 according to various embodiments of the disclosure may include a connector 440 connected to an external electronic device 810. Referring to FIG. 8, the connector 440 may be an interface connected to an external electronic device capable of supplying power to the electronic device 400. However, the connector 440 is not limited to the interface connected to an external electronic device capable of supplying power. For example, the connector 440 may be an interface, which is a USB (universal series bus)-type connector, connected to any of various external electronic devices supporting the USB type (e.g., speakers, earphones, external batteries, or the like). According to various embodiments of the disclosure, if an external electronic device is connected through the connector 440, the sensing circuit 510 may detect a change in the physical quantity even though an object (e.g., a human hand, an accessory device, etc.) is not in proximity to (or is not in contact with) the sensing circuit 510. This is due to the fact that the external electronic device may cause a change in the physical quantity measured by the sensing circuit 510 when the external electronic device is connected through the connector 440.

The processor 520 of the electronic device 400 according to various embodiments of the disclosure may detect an interrupt in response to a connection of the external electronic device 810 to the electronic device 400 through the connector 440.

The processor 520 may identify whether the detected interrupt is a predetermined interrupt. For example, the processor 520 may identify whether or not the detected interrupt corresponds to an interrupt generated when a specific external electronic device (e.g., an external electronic device capable of supplying power) is connected, among interrupts generated when various external electronic devices are connected. The processor 520 may reset the sensing circuit 510 in response to identifying that the detected interrupt is a predetermined interrupt.

According to various embodiments of the disclosure, the processor 520 may reset the sensing circuit 510 by setting, as a reference value, the measurement value measured by the sensing circuit 510 when the external electronic device 810 is connected.

An electronic device according to various embodiments of the disclosure may include: a housing; a conductive element positioned at a portion of the housing or inside the housing; a sensing circuit electrically connected to the conductive element and configured to sense contact or proximity of an external object; and a processor, wherein the processor may be configured to detect the generation of an interrupt, identify whether or not the generated interrupt is a predetermined interrupt, and reset the sensing circuit, based on at least one of a result of identifying whether or not the generated interrupt is a predetermined interrupt or an output value of the sensing circuit.

In addition, in an electronic device according to various embodiments of the disclosure, the processor may reset a physical quantity measured by the sensing circuit at a time corresponding to the generation of the interrupt as a reference value.

In addition, in an electronic device according to various embodiments of the disclosure, if the measurement value measured by the sensing circuit exceeds a first threshold value, the processor may identify whether or not the measurement value is maintained for a predetermined period of time or more, and if the measurement value is maintained for the predetermined period of time or more, the processor may reset the sensing circuit.

In addition, in an electronic device according to various embodiments of the disclosure, if a measurement value measured by the sensing circuit and exceeding a first threshold value is changed to be less than the first threshold value, the processor may identify whether or not the measurement value is maintained for a predetermined period of time or more, and if the measurement value is maintained for the predetermined period of time or more, the processor may reset the sensing circuit.

In addition, in an electronic device according to various embodiments of the disclosure, if a difference between a measurement value measured by the sensing circuit and a reference value exceeds a reference amount of change, the processor may identify whether or not the measurement value is maintained for a predetermined period of time or more, and if the measurement value is maintained for the predetermined period of time or more, the processor may reset the sensing circuit.

In addition, in an electronic device according to various embodiments of the disclosure, if the number of times the sensing circuit is reset exceeds a predetermined number, the processor may adjust a second threshold value.

In addition, in an electronic device according to various embodiments of the disclosure, if a difference between a measurement value measured using two or more conductive elements and a reference value exceeds a predetermined difference value, the sensing circuit may identify whether or not the measurement value is maintained for a predetermined period of time or more, and if the measurement value is maintained for the predetermined period of time or more, the sensing circuit may be reset.

In addition, in an electronic device according to various embodiments of the disclosure, the conductive element may be an antenna used to perform communication of the electronic device.

In addition, in an electronic device according to various embodiments of the disclosure, the electronic device may further include a sensor configured to sense whether or not an accessory device, which covers at least a portion of one surface of the housing, is attached to the one surface, and the processor may identify whether or not an interrupt transmitted from the sensor is the predetermined interrupt, thereby resetting the sensing circuit.

In addition, in an electronic device according to various embodiments of the disclosure, the sensor may be a hall sensor configured to sense magnetic force, and the processor may identify whether the attachment state of the accessory device with respect to the one surface is a stand mode state or a cover state according to the position in which the magnetic force is sensed.

In addition, in an electronic device according to various embodiments of the disclosure, if a signal sensed by the sensor is the predetermined interrupt, the processor may perform control so as not to reduce the intensity of a radio wave radiated from the electronic device.

In addition, in an electronic device according to various embodiments of the disclosure, the electronic device may further include a connector connected to an external electronic device, and the processor may determine whether or not an interrupt generated by a connection of the external electronic device through the connector is the predetermined interrupt.

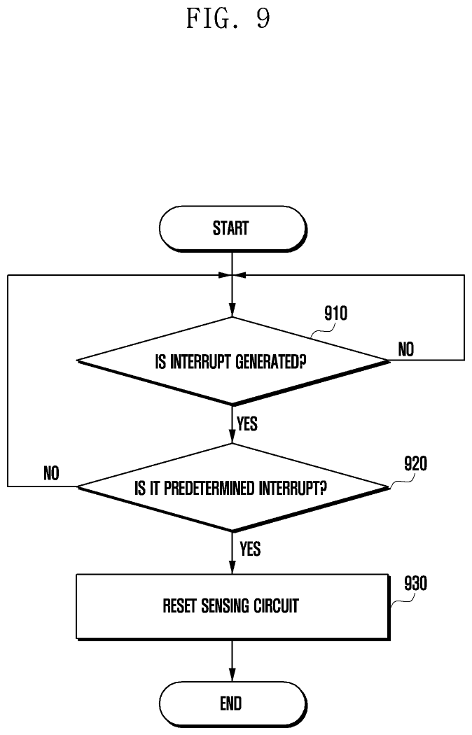

FIG. 9 is a flowchart illustrating a method of controlling the operation of an electronic device according to various embodiments of the disclosure.

Referring to FIG. 9, first, the processor 510 may detect whether or not an interrupt has been generated. The interrupt may be a signal generated from any of various components of the electronic device 400 (e.g., the sensing circuit 510 or the like).

In response to detection of the generation of the interrupt, the processor 510 may identify whether or not the generated interrupt is a predetermined interrupt (920). According to various embodiments of the disclosure, the predetermined interrupt may be an interrupt corresponding to various conditions requiring an operation of resetting the sensing circuit 510.

The interrupt and the predetermined interrupt have been described in detail with reference to FIG. 5 above, which will be omitted here.

Based on at least one of a result of identifying whether or not the generated interrupt is a predetermined interrupt or an output value of a sensing circuit connected to at least one antenna and detecting that an external object comes into contact with or is in proximity to a predetermined area of a housing, the processor 510 may reset the sensing circuit (930).

According to various embodiments of the disclosure, if the difference between an output value of the sensing circuit and a reference value exceeds a reference amount of change, or if an output value of the sensing circuit 510 exceeds a first threshold value, the processor 520 may identify whether or not the output value of the sensing circuit 510 is maintained for a predetermined period of time or more. If the output value of the sensing circuit 510 is maintained for a predetermined period of time or more, the processor 510 may reset the sensing circuit 510.

As described above, resetting the sensing circuit 510 may be setting a new reference value of the sensing circuit 510. According to various embodiments of the disclosure, the processor 510 may set, as a reference, the measurement value measured by the sensing circuit 510 at the time at which the interrupt is generated, thereby resetting the sensing circuit. Resetting the sensing circuit 510 may be an operation of preventing unnecessary operation of the sensing circuit 510.

In addition, resetting the sensing circuit 510 may be adjusting the second threshold value. The second threshold value may be a value used to sense whether or not the user is holding the electronic device. If a value output from the sensing circuit 510 exceeds the second threshold value, the processor 520 may identify that the electronic device 400 is held by the user.

If the generated interrupt is not a predetermined interrupt, the processor 510 may continue to detect whether or not an interrupt is generated.

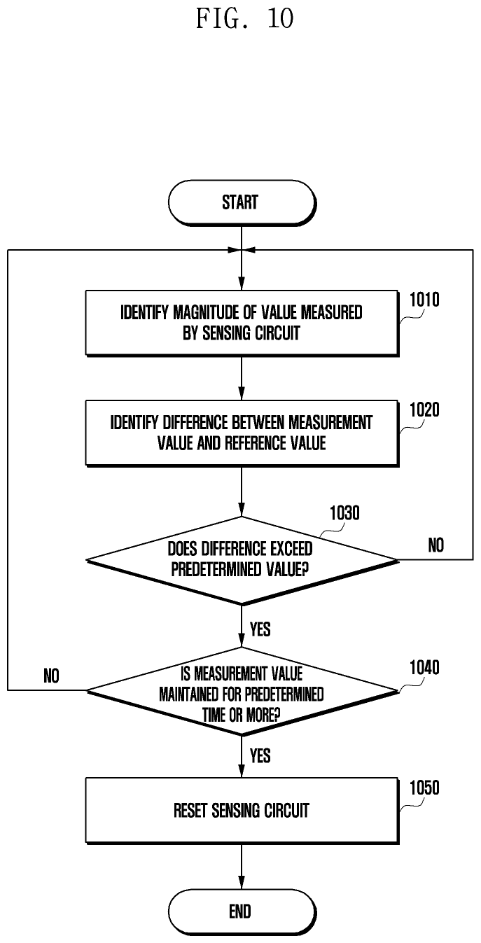

FIG. 10 is a flowchart illustrating an operation of resetting a sensing circuit in a method of controlling the operation of an electronic device according to various embodiments of the disclosure.

First, the processor 520 may identify the magnitude of the measurement value measured by the sensing circuit 510 (1010). According to various embodiments of the disclosure, the sensing circuit 510 may be a sensor that measures a physical quantity (e.g., capacitance) that changes depending on the distance between the sensing circuit 510 and an object. For example, the measurement value may be a capacitance value.

The processor 520 may identify the difference between the measurement value and a reference value (1020), and may identify whether or not the difference exceeds a predetermined value (1030). Alternatively, the processor 520 may identify whether or not the measurement value exceeds a first threshold value. The predetermined value may vary with the number of resets of the sensing circuit 510.

If the difference value exceeds a predetermined value, or if the measurement value exceeds a first threshold value, the processor 520 may identify whether or not the measurement value is maintained for a predetermined period of time or more (1040). According to another embodiment, the processor 520 may identify whether or not the measurement value is maintained within a predetermined range for a predetermined period of time or more. The processor 520 may determine that the interrupt is the predetermined interrupt in response to identifying that the interrupt satisfies the above conditions.

The processor 520 may reset the sensing circuit 510 in response to identifying whether or not the measurement value is maintained for a predetermined period of time or more (1050).

According to various embodiments of the disclosure, resetting the sensing circuit 510 may include setting a measurement value as a reference value. In addition, if the measurement value is maintained for a predetermined period of time or more, the processor 520 may set a reference amount of change previously set as a difference value between a measurement value and a reference value. In addition, the processor 520 may adjust the second threshold value in response to identifying that the measurement value is maintained for a predetermined period of time or more. In addition, the processor 520 may adjust the sensitivity of the sensing circuit 510. Adjusting the sensitivity may mean that an output value may differ even if the amounts of changes in the physical quantity generated when external objects (e.g., a user's hand or the like) come into contact with (or are in proximity to) the electronic device 400 are the same.

The processor 520 may reset the sensing circuit 510 by setting the measurement value of the sensing circuit 510 corresponding to the time at which an interrupt is generated as a reference value. Referring back to Table 1, it can be seen that the measurement value of the sensing circuit 510 corresponding to the time at which an interrupt is generated is “170”, which is a first measurement value. The processor 520 may reset the reference value to “170”. If the newly set reference value “170” exceeds the threshold value “93”, the processor 520 may detect that an interrupt has been generated, and may repeat the operations described above.

If the measurement value is maintained for a predetermined period of time or more, the processor 520 may determine that the interrupt is a predetermined interrupt, and may reset the sensing circuit 510 in response thereto. The processor 520 may reset the sensing circuit 510 by setting the measurement value of the sensing circuit 510 corresponding to the time at which the interrupt is generated as a reference value.

A method for controlling the operation of an electronic device according to various embodiments of the disclosure may include: detecting the generation of an interrupt; determining whether or not the generated interrupt is a predetermined interrupt; and, based on at least one of a result of determining whether or not the generated interrupt is the predetermined interrupt or an output value of a sensing circuit, which is electrically connected to a conductive element positioned at a portion of a housing or inside the housing and senses contact or proximity of an external object, resetting the sensing circuit.

In a method for controlling the operation of an electronic device according to various embodiments of the disclosure, the resetting of the sensing circuit may include resetting a physical quantity measured by the sensing circuit at a time corresponding to the generation of the interrupt as a reference value.

In a method for controlling the operation of an electronic device according to various embodiments of the disclosure, the resetting of the sensing circuit may include: if a measurement value measured by the sensing circuit exceeds a first threshold value, identifying whether or not the measurement value is maintained for a predetermined period of time or more; and if the measurement value is maintained for the predetermined period of time or more, resetting the sensing circuit.

In a method for controlling the operation of an electronic device according to various embodiments of the disclosure, the resetting of the sensing circuit may include: if a measurement value measured by the sensing circuit and exceeding a first threshold value is changed to be less than the first threshold value, identifying whether or not the measurement value is maintained for a predetermined period of time or more; and if the measurement value is maintained for the predetermined period of time or more, resetting the sensing circuit.

In a method for controlling the operation of an electronic device according to various embodiments of the disclosure, the resetting of the sensing circuit may include: if a difference between a measurement value measured by the sensing circuit and a reference value exceeds a reference amount of change, identifying whether or not the measurement value is maintained for a predetermined period of time or more; and if the measurement value is maintained for the predetermined period of time or more, resetting the sensing circuit.

In a method for controlling the operation of an electronic device according to various embodiments of the disclosure, the method for controlling the operation of an electronic device may further include, if the number of times the sensing circuit is reset exceeds a predetermined number, adjusting a second threshold value.

In a method for controlling the operation of an electronic device according to various embodiments of the disclosure, the resetting of the sensing circuit may include: if a difference between a measurement value measured using two or more conductive elements and a reference value exceeds a reference amount of change, identifying whether or not the measurement value is maintained for a predetermined period of time or more; and if the measurement value is maintained for the predetermined period of time or more, resetting the sensing circuit.

In a method for controlling the operation of an electronic device according to various embodiments of the disclosure, the resetting of the sensing circuit may include setting a different value between the measurement value and the reference value as a reference amount of change.

In a method for controlling the operation of an electronic device according to various embodiments of the disclosure, the determining whether or not the generated interrupt is the predetermined interrupt may include identifying whether or not an interrupt transmitted from the sensor configured to sense attachment or detachment of an accessory device, which covers at least a portion of one surface of the electronic device, is the predetermined interrupt, thereby resetting the sensing circuit.

In a method for controlling the operation of an electronic device according to various embodiments of the disclosure, the sensor may be a hall sensor configured to sense magnetic force, and the method for controlling the operation of an electronic device may further include identifying whether the attachment state of the accessory device with respect to one surface is a stand mode state or a cover state according to the position in which the magnetic force is sensed.

In a method for controlling the operation of an electronic device according to various embodiments of the disclosure, the method for controlling the operation of an electronic device may further include performing control so as not to reduce the intensity of a radio wave radiated from the electronic device if a signal sensed by the sensor is the predetermined interrupt.

In a method for controlling the operation of an electronic device according to various embodiments of the disclosure, the detecting the generation of an interrupt may further include determining whether or not an interrupt generated by a connection of the external electronic device through the connector is the predetermined interrupt.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof The “module” may be a minimum unit for performing one or more functions or a part thereof. The “module” may be implemented mechanically or electronically. For example, the “module” according to an embodiment of the present disclosure may include at least one of an application-specific integrated circuit (ASIC) chip, a field-programmable gate array (FPGA), and a programmable-logic device for performing certain operations which have been known or are to be developed in the future.

1. An electronic device comprising:
a housing;
a conductive element positioned at a portion of the housing or inside the housing;
a sensing circuit electrically connected to the conductive element and configured to sense contact or proximity of an external object; and
a processor,
wherein the processor is configured to detect the generation of an interrupt, identify whether or not the generated interrupt is a predetermined interrupt, and reset the sensing circuit, based on at least one of a result of identifying whether or not the generated interrupt is a predetermined interrupt or an output value of the sensing circuit.

2. The electronic device of claim 1, wherein the processor sets a physical quantity measured by the sensing circuit at a time corresponding to the generation of the interrupt as a reference value.

3. The electronic device of claim 1, wherein if the measurement value measured by the sensing circuit exceeds a first threshold value, the processor identifies whether or not the measurement value is maintained for a predetermined period of time or more, and
wherein if the measurement value is maintained for the predetermined period of time or more, the processor resets the sensing circuit.

4. The electronic device of claim 1, wherein if a measurement value measured by the sensing circuit and exceeding a first threshold value is changed to be less than the first threshold value, the processor identifies whether or not the measurement value is maintained for a predetermined period of time or more, and
wherein if the measurement value is maintained for the predetermined period of time or more, the processor resets the sensing circuit.

5. The electronic device of claim 1, wherein if a difference between a measurement value measured by the sensing circuit and a reference value exceeds a reference amount of change, the processor identifies whether or not the measurement value is maintained for a predetermined period of time or more, and
wherein if the measurement value is maintained for the predetermined period of time or more, the processor resets the sensing circuit.

6. The electronic device of claim 5, wherein if a number of times the sensing circuit is reset exceeds a predetermined number, the processor adjusts a second threshold value.

7. The electronic device of claim 1, wherein if a difference between a measurement value measured using two or more conductive elements and a reference value exceeds a predetermined difference value, the sensing circuit identifies whether or not the measurement value is maintained for a predetermined period of time or more, and
wherein if the measurement value is maintained for the predetermined period of time or more, the sensing circuit is reset.

8. The electronic device of claim 5, wherein the conductive element is an antenna used to perform communication of the electronic device.

9. The electronic device of claim 1, further comprising a sensor configured to sense whether or not an accessory device, which covers at least a portion of one surface of the housing, is attached to the one surface,
wherein the processor identifies whether or not an interrupt transmitted from the sensor is the predetermined interrupt, thereby resetting the sensing circuit.

10. The electronic device of claim 7, wherein the sensor is a hall sensor configured to sense magnetic force, and
wherein the processor identifies whether the attachment state of the accessory device with respect to the one surface is a stand mode state or a cover state according to the position in which the magnetic force is sensed.

11. The electronic device of claim 7, wherein if a signal sensed by the sensor is the predetermined interrupt, the processor performs control so as not to reduce the intensity of a radio wave radiated from the electronic device.

12. The electronic device of claim 1, further comprising a connector connected to an external electronic device,
wherein the processor determines whether or not an interrupt generated by a connection of the external electronic device through the connector is the predetermined interrupt.

13. A method for controlling the operation of an electronic device, the method comprising:
detecting the generation of an interrupt;
determining whether or not the generated interrupt is a predetermined interrupt; and
based on at least one of a result of determining whether or not the generated interrupt is the predetermined interrupt or an output value of a sensing circuit, which is electrically connected to a conductive element positioned at a portion of a housing or inside the housing and senses contact or proximity of an external object, resetting the sensing circuit.

14. The method of claim 13, wherein the resetting of the sensing circuit comprises resetting a physical quantity measured by the sensing circuit at a time corresponding to the generation of the interrupt as a reference value.

15. The method of claim 13, wherein the resetting of the sensing circuit comprises:
if a measurement value measured by the sensing circuit exceeds a first threshold value, identifying whether or not the measurement value is maintained for a predetermined period of time or more; and
if the measurement value is maintained for the predetermined period of time or more, resetting the sensing circuit.
